(19) United States
(12) Patent Application Publication
(10) Pub. No.: US 2006/0180681 A1
(43) Pub. Date: Aug. 17, 2006

(54) Faucet adaptor

(75) Inventor: Ping Wa Lau, Hong Kong (HK)

Correspondence Address: David Wolf;Wolf, Greenfield & Sacks, P.C., 600 Atlantic Avenue, Boston, MA, 02210-2206, US

(73) Assignee: Jing Mei Industrial Holdings Limited, Avarua (CK)

(21) Appl. No.: 11/050,415

(22) Filed: Feb. 2, 2005

(51) Int. Cl. B05B 1/34

(52) U.S. Cl. 239/383; 239/381

(57) ABSTRACT

A faucet adaptor with a coaxial arrangement of an outer shell, a cover within the shell, a rotor at least partially within the cover, and a faceplate secured to the shell to secure the coaxial arrangement. A passage from the shell through the cover directs fluid from a source onto the rotor and then through the rotor and out of the adapter. The faucet adapter may enable the exiting spray of fluid to have a cone-like shape and the exit angle of the fluid may be altered depending on user-preferences.

### FIELD OF THE INVENTION

The present invention relates to an improved faucet adaptor and, in particular, a faucet adaptor designed for use as a showerhead, water sprayer, faucet, or similar water dispensing device designed for attachment to a conventional water supply system found in buildings.

### BACKGROUND OF THE INVENTION

Faucet adaptors intended to control the force with which water is emitted frequently involve simple constrictors that convert the flow of water into a number of small diameter streams, and provide no other function. These units are unifunctional and do not provide means for altering pressure, direction, flow or conformity of water passage.

### SUMMARY OF THE INVENTION

The invention provides a novel faucet adaptor designed to alter the pressure, rate of flow and/or direction of fluid flow from the faucet. For example, the faucet adaptor of the present invention may be configured to expel a massaging, pulsing spray or a softer, continuous shower.

The invention provides a faucet adaptor constructed and arranged to connect to a water source to modify the flow characteristics of fluid exiting the water source. The faucet adaptor may include an inlet constructed and arranged to receive fluid at a first pressure, an outlet constructed and arranged to dispense fluid at a second pressure, and a passageway extending between the inlet and the outlet. The passageway may include a rotor.

The present invention also composes a method of altering flow of fluid in a faucet having an inlet and an outlet by using a fluid driven rotor having at least one blade between the inlet and outlet. The method may include flowing fluid at a first pressure into the inlet, rotating the rotor to alter the flow of fluid, and flowing fluid at a second different pressure out of the outlet.

The invention also provides a faucet adaptor for enhancing the rate and direction of flow of fluid from a fluid source to which the faucet adaptor is connected. The faucet adaptor may include a coaxial array of a shell, a cover at least partially disposed within the shell, a rotor at least partially disposed within the cover, a faceplate engaging the shell and securing the cover and rotor in a selected position, means defining fluid passages between the cover and shell with the passages opening into the interior of the cover to direct fluid onto and for rotation of the rotor, and passages outwardly through the rotor plate.

Various embodiments of the present invention provide certain advantages. Not all embodiments of the invention share the same advantages and those that do may not share them under all circumstances.

Further features and advantages of the present invention, as well as the structure of various embodiments of the present invention are described in detail below with reference to the accompanying drawings.

### BRIEF DESCRIPTION OF DRAWINGS

Various embodiments of the invention will now be described, by way of example, with reference to the accompanying drawings, in which:

FIG. 1 is an exploded view of one embodiment of the faucet adaptor;

FIG. 2A is a perspective view of the shell shown in FIG. 1;

FIG. 2B is a top view of the shell of FIG. 2A;

FIG. 2C is a cross-sectional view taken along line 2C-2C of the shell shown in FIG. 2B;

FIG. 2D is a cross-sectional view taken along line 2D-2D of the shell shown in FIG. 2B;

FIG. 3A is a perspective view of the cover shown in FIG. 1;

FIG. 3B is a top view of the cover of FIG. 3A;

FIG. 3C is a cross-sectional view taken along line 3C-3C of the cover shown in FIG. 3B;

FIG. 3D is a cross-sectional view taken along line 3D-3D of the cover shown in FIG. 3C;

FIG. 3E is a cross-sectional view taken along line 3E-3E of the cover shown in FIG. 3B;

FIG. 4A is a perspective view of the rotor shown in FIG. 1;

FIG. 4B is a top view of the rotor of FIG. 4A;

FIG. 4C is a cross-sectional view taken along line 4C-4C of the rotor shown in FIG. 4B;

FIG. 4D is a cross-sectional view taken along line 4D-4D of the rotor shown in FIG. 4C;

FIG. 4E is a cross-sectional view taken along line 4E-4E of the rotor shown in FIG. 4B;

FIG. 5A is a perspective view of the rotor head shown in FIG. 1;

FIG. 5B is a top view of the rotor head of FIG. 5A;

FIG. 5C is a cross-sectional view taken along line 5C-5C of the rotor head shown in FIG. 5B;

FIG. 5D is a cross-sectional view taken along line 5D-5D of the rotor head shown in FIG. 5B;

FIG. 6A is a perspective view of the faceplate shown in FIG. 1;

FIG. 6B is a top view of the faceplate of FIG. 6A;

FIG. 6C is a cross-sectional view taken along line 6C-6C of the faceplate shown in FIG. 6B;

FIG. 6D is a cross-sectional view taken along line 6D-6D of the faceplate shown in FIG. 6B;

FIG. 7A is a perspective view of the assembled faucet adaptor shown in FIG. 1;

FIG. 7B is a top view of the faucet adaptor of FIG. 7A;

FIG. 7C is a cross-sectional view taken along line 7C-7C of the faucet adaptor shown in FIG. 7B;

FIG. 7D is a cross-sectional view taken along line 7D-7D of the faucet adaptor shown in FIG. 7C; and

FIG. 7E is a cross-sectional view taken along line 7E-7E of the faucet adaptor shown in FIG. 7B.

### DETAILED DESCRIPTION OF EMBODIMENTS OF THE INVENTION

The present invention is described in connection with an embodiment specifically designed for use as faucet adaptor and in particular to a faucet adaptor capable of connection to a conventional, household water system. The faucet adaptor is constructed and arranged to enhance the rate and direction of flow of fluid from a faucet to which the faucet adaptor is connected. In one embodiment the faucet adaptor includes an inlet, an outlet, a passageway disposed therebetween and a rotor contained within the passageway. The rotor may be constructed and arranged to alter the characteristics of fluid as it passes through the faucet adaptor.

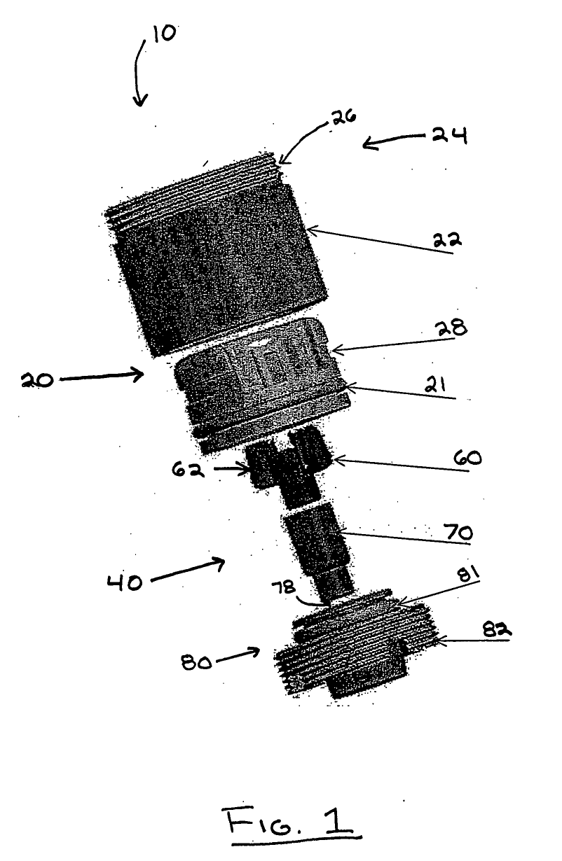

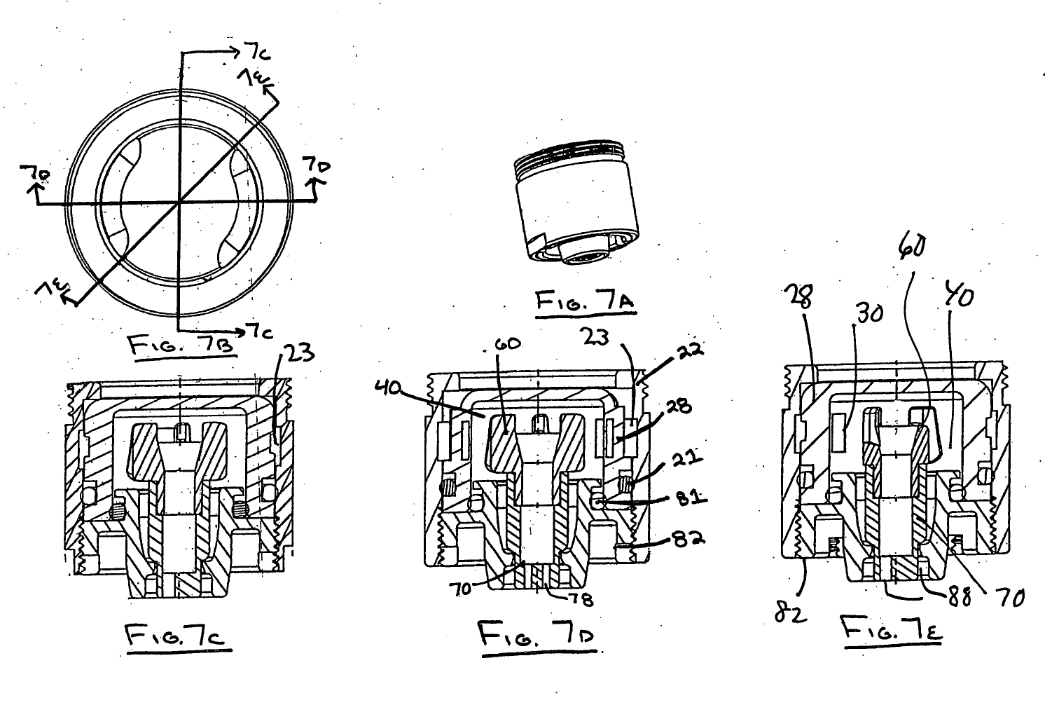

In the embodiment, shown in FIGS. 1 and 7A-7E, the faucet adaptor 10 may include an inlet 20, a passageway 40, a rotor 60 partially positioned in the passageway 40 and an outlet 80. The inlet 20 is defined by a shell 22 and a cover 28 that is coaxially positioned within the shell 22. The cover 28 fits within the shell 22. A space between the cover 28 and shell 22 define an annular passage for fluid flow from the faucet or water source attached to the faucet adaptor at the inlet end of the shell. The annular passage is sealed at its lower end by an o-ring 21 that fits into an annular groove at the lower end of the cover 28. The cover 28 is sealably attached by an o-ring 81 to a faceplate 82 to form the passageway 40. The rotor 60 is positioned in passageway 40. The rotor preferably has four blades 62 that are constructed and arranged to assist in altering the characteristics of the fluid. The rotor 60 is rotatably journaled in a rotor head or holder 70, for free rotation. The outlet 80 is in part defined by the space between the cover 28 and the rotor head 70 and the outlet holes 78, through which the fluid may exit the passageway 40 and exit the faucet adaptor 10.

The inlet 20 provides a passage for fluid into the faucet adaptor to the passageway 40 containing the rotor. As shown in FIG. 1, the inlet 20 includes the shell 22 having a connector 24 with standard external pipe threads 26 at its upper end for attachment to a conventional faucet or water source. The cover 28 disposed within the shell 22 and is spaced from it providing an annular passage 23 (FIG. 8d) between the shell 22 and cover 28. The cover 28 has a pair of inlet holes 30 for the water to move from the annular passage 23 through the inlet holes 30 into passageway 40.

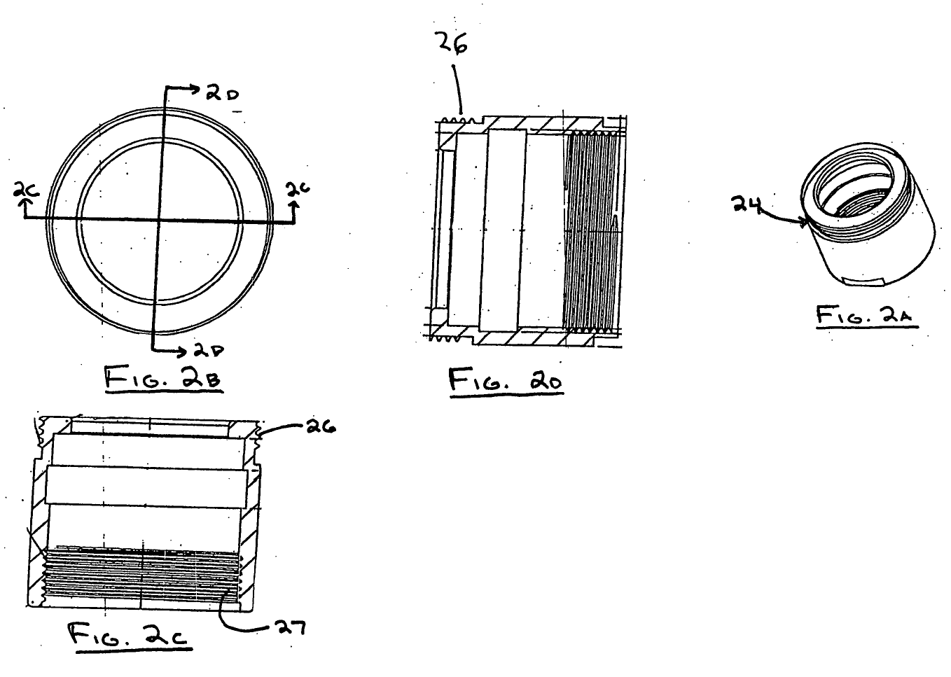

As is shown in FIGS. 2A-D, the shell 22 comprises an open-ended cylinder having two sets of threads 26, 27, one on either end of the cylinder. Threads 26 is external, while threads 27 is internal. The shell 22 is connected by the threads 26 at one end to the fluid source such as a conventional water tap having a corresponding internal threaded section for engagement with threads 26. Threads 27 are connected to the faceplate 82 as will be described further below. While this embodiment describes a connector 24 with threads 26 connected to the inside of the end of a faucet, the connector 24 may use other conventional means.

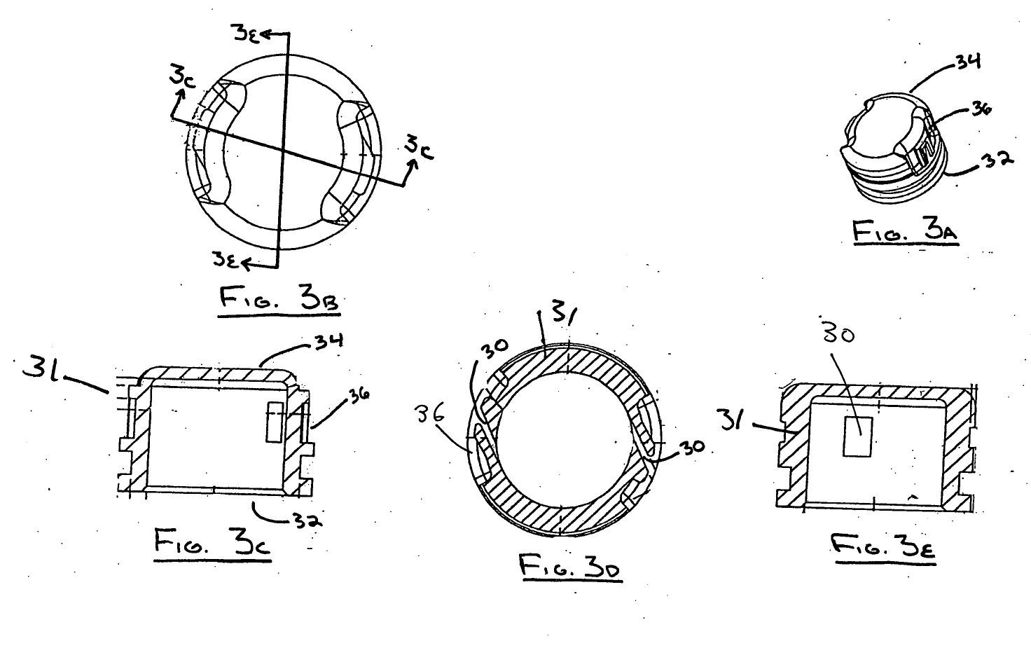

The shell 22 and cover 28 define an inlet between them for the water to enter the passageway 40. As shown in FIGS. 3A-E, the cover 28 has a cylinder shape with an open end 32 and a closed end 34. Inlet holes 30 in the annular wall 31 for water to enter the passageway 40 may be located more proximate the closed end 34. These inlet holes or slots 30 extend substantially tangential from the inside surface of the wall 31 to the outside. The outer end of the holes are in direct fluid connection with channels 36 on the outer sides of the cover. Fluid moves through the channels 36 into the inlet holes 30. The two inlet holes are located opposite each other and are sized and angled to direct the flow of fluid onto the blades of the rotor, herein described, with sufficient force to cause the rotor blades to turn. In another embodiment, the inlet holes may be straight.

Although the inlet 20 is shown as including two pieces (e.g., the shell 22 and the cover 28), the function of the inlet, i.e., allowing water to enter the passageway 40, may be achieved using pieces having a variety of shapes provided fluid is passed onto the blades with significant force to rotate the rotor as described.

When the water exits the inlet holes 30, it enters the passageway 40 formed between the cover 28 and the faceplate 82 (FIG. 7E). Positioned within the passageway 40 is the rotor 60 and rotor head 70.

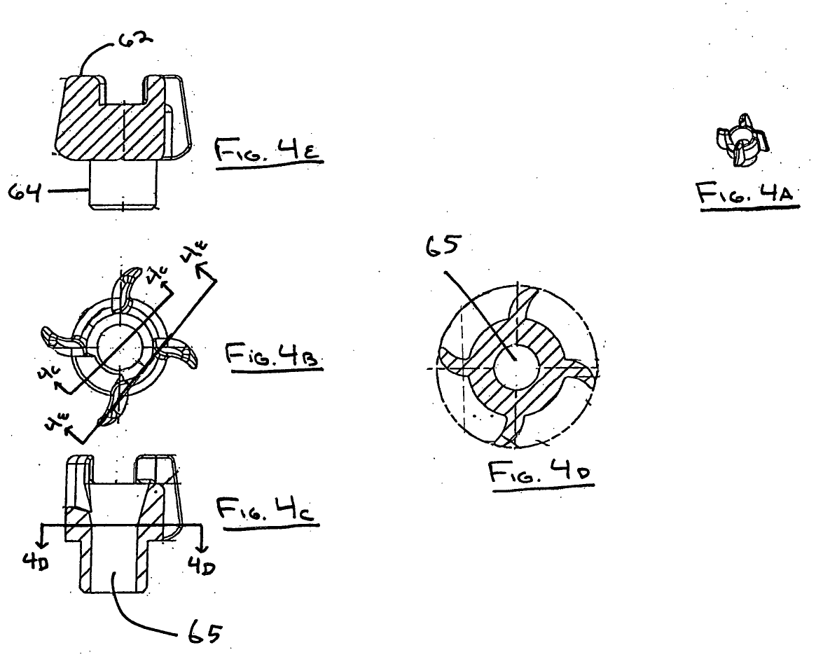

As is shown in FIGS. 4A-E, the rotor 60 includes 4 blades 62 that are slightly concave to cup the water so as to easily generate an initial torque to start, and a cylindrical shaft 64 that is sized and shaped to be rotatably supported by the rotor head. The number of blades used may vary depending on the specific uses and design of the unit. The shaft 64 has an axial passage 65 through it. The shape of the tip of the rotor blade may affect the direction, pressure and/or timing of the water as it is expelled from the faucet adaptor.

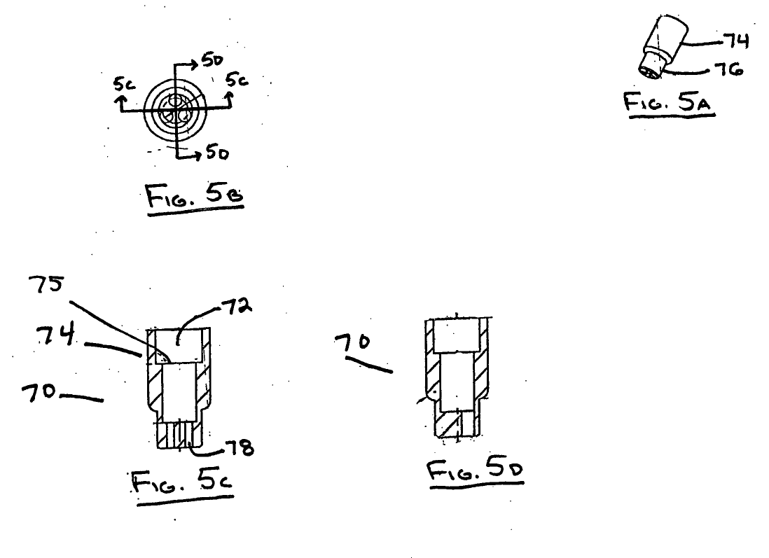

The cylindrical shaft 64 of the rotor 60 fits into the cylindrical opening 72 in the top portion 74 of the rotor head 70. The portion 74 is formed with an annular seat 75 in the opening 72 (FIG. 5C) to receive and rotatably support the shaft 64 (FIGS. 5A-D). The rotor head 70 includes a top portion 74 with a cylindrical opening 72 and a bottom portion 76 having outlet holes 78 continuous with the opening 72. The bottom portion 76 is shaped and sized for support on the faceplate 82, with the outlet holes 78 directed downwardly. The rotor head may contain any number of outlet holes, such as 2, 3, or 4 as the present invention is not intended to be limited in this respect.

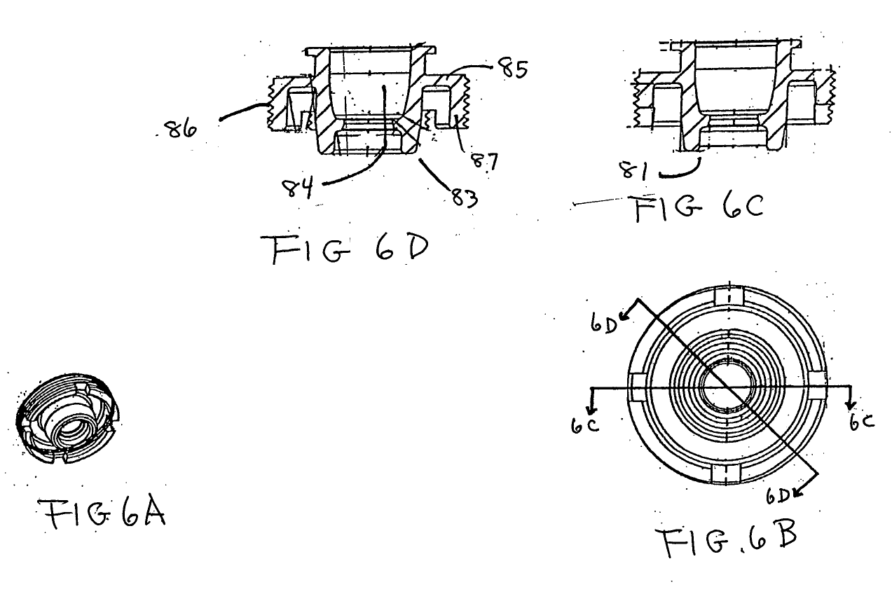

The faceplate 82 (FIGS. 6A-D) includes an opening 84 in which the bottom portion 76 of the rotor head 70 may be seated and it is also the pivot location for the rotation of the rotor head. In this manner the swirl is generated in the rotor 60 which then oscillates in the rotor head 70 in the tilted position to spout washing water from the rotor head opening. The face plate 82 has a central core 81 which is essentially frusto conic in shape. The passage 84 extends through it with a construction at its lower end sized to engage and retain the lower end 76 of the rotor head 70 and with the end of the lower end 76 extending to the bottom 83 of the core 81. A flange 85 radially extends from the outer wall of core 81 and terminates in a depending wall 87 which has the threads 86. The threads 86 engage threads 27 of the shell, thereby sandwiching the cover 28, rotor 60 and rotor head 70 between the shell 22 and the faceplate 82. The openings 88 in the faucet adapter may be directed to cause the exiting spray of water to have a cone-like shape. If a user prefers a gentler, softer spray, the outlet holes may be slanted and sized to achieve a decreased pressure and rate of flow. The water exiting may be in the shape of a cone with a wider angle.

Because the faucet adaptor may be constructed and arranged to expel water at a greater pressure than that which enters the adaptor, in one embodiment the pressure of the water entering the faucet adaptor may be approximately 10 psi. The pressure of the water may also be greater than or less than 10 psi, as the present invention is not intended to be limiting in this respect.

Any materials, such as plastics and metals, such as stainless steel or combinations thereof or any other materials may be used in making the faucet adaptor and pieces thereof, as the present invention is not intended to be limiting in this respect. For example, in one embodiment, the shell and faceplate may be stainless steel. In another embodiment, the shell and faceplate may be of colored plastic to match the material of the faucet.

Depending on the faucet, or other water source, or desired use, the faucet adaptor and components thereof may have any dimension.

In the operation of this faucet adaptor, when connected to a water tap, water passes through the tap into the inlet end of the faucet adapter and through the annular passage 23 and then through the holes 30 onto the rotor blades causing them to spin. The water passes out of the adapter through openings 80 with a spray pattern that depends on the rotational speed of the rotor.

The foregoing written specification is to be considered to be sufficient to enable one skilled in the art to practice the invention. While the best mode for carrying out the invention has been described in detail, those skilled in the art to which this invention relates will recognize various alternative embodiments including those mentioned above as defined by the following claims. The examples disclosed herein are not to be construed as limiting of the invention as they are intended merely as illustrative of particular embodiments of the invention as enabled herein. Therefore, systems and methods that are functionally equivalent to those described herein are within the spirit and scope of the claims appended hereto. Indeed, various modifications of the invention in addition to those shown and described herein will become apparent to those skilled in the art from the foregoing description and fall within the scope of the appended claims.

What is claimed is:

1. A faucet adaptor for connection to a water source comprising:
means having an inlet to receive fluid at a first pressure;
an outlet for dispensing fluid at a second pressure;
means defining a passageway between the inlet and the outlet, and a rotor positional in the passageway for re-directing fluid moving through the passageway.

2. The faucet adaptor of claim 1, wherein the rotor includes four blades.

3. The faucet adaptor of claim 1, wherein a cross-sectional area of the inlet is greater than a cross-sectional area of the outlet.

4. The faucet adaptor of claim 6, wherein the outlet includes outlet holes and the cross-section total cross-sectional areas of the outlet holes is less than the cross sectional area of the inlet.

5. The faucet adaptor of claim 1, wherein the rotor includes a plurality of blades extending outwardly from a cylindrical shaft, said shaft having an axial passage for fluid involvement out of the adapter.

6. The faucet adaptor of claim 11, wherein the rotor blades are concave.

7. A faucet adaptor for enhancing the rate and direction of flow of fluid from a fluid source to which the faucet adaptor is connected comprising a coaxial array of:
a shell;
a cover at least partially disposed within the shell;
a rotor at least partially disposed within the cover;
a faceplate engaging the shell and securing the cover and rotor in a selected position;
means defining fluid passages between the cover and shell with the passages in the cover opening into the interior of the cover to direct fluid onto and rotate the rotor; and
passages from the rotor to and outwardly through the faceplate.

8. A faucet adapter as set forth in claim 7 wherein the passages in the cover extending therethrough in a substantially tangential direction from the inner surface of the cover.

9. A faucet adapter as set forth in claim 8 wherein said rotor has an axial passage extending therethrough for passage of water out of the adapter.
